(19) United States
(12) Patent Application Publication
(10) Pub. No.: US 2004/0223405 A1
(43) Pub. Date: Nov. 11, 2004

(54) Mounting assembly for plastic bulk container

(75) Inventor: Shaun Mott, Richmond (CA)

Correspondence Address: PAUL A. GUSS, PAUL A. GUSS ATTORNEY AT LAW, 775 S 23RD ST FIRST FLOOR SUITE 2, ARLINGTON, VA, 22202

(73) Assignee: Dynamix Agitators Inc.

(21) Appl. No.: 10/730,062

(22) Filed: Dec. 9, 2003

Related U.S. Application Data
(60) Provisional application No. 60/431,688, filed on Dec. 9, 2002.

(51) Int. Cl. B01F 7/00

(52) U.S. Cl. 366/242; 366/244; 366/247; 366/249; 366/331

(57) ABSTRACT

A mounting assembly for a mixer for materials which need to be mixed during transit in a container with an impeller connected to a drive shaft, wherein the impeller and its shaft are mounted in an assembly which extends through an opening into the container. The assembly includes a lip mount to stabilize and support the mixer on the lip of said container. A cover secures said lip mount with threaded fasteners engaging complementary fasteners on the container neck and clamping the plate to the container lip. A primary objective of the invention is to allow stable mounting of a mixing unit to plastic bulk containers.

This application claims the benefit of U.S. Provisional Application No. 60/431,688 filed Dec. 9, 2002, which is herein incorporated by reference.

### TECHNICAL FIELD

The present invention relates generally to fluid mixing units. More particularly, the present invention relates to apparatus employed in conjunction with portable containers for agitating, mixing and/or blending of fluids while the fluids are in transit. Yet more particularly, the present invention relates to an assembly for fluid mixing units wherein an impeller module is affixed to a plastic container for fluids.

### BACKGROUND

Many industries transport, store, mix and/or discharge fluids from commercial plastic bulk containers, commonly known in the trade as “tote boxes” or “plastic bulk containers” (both herein referred to as “containers”). It is often desirable, and in some cases required, that the fluids stored in such containers be agitated, mixed or blended between the time they are loaded into the containers and the time they are discharged therefrom. In order to affect the desired mixing, in the prior art it was necessary to open the container and insert a mixing unit with impeller blades. There are, however, several drawbacks to this approach.

A first disadvantage is that as a plurality of containers are usually stored in close proximity, it may be difficult to access the selected container in the manner required not only to remove the lid, or open the port provided, but also to insert the mixing unit. But even if the lid, or the port, is readily accessible, it may be difficult to remove the lid, or open the port, particularly if the material in the container is highly volatile and the lid or port had been sealed to retain the vapors.

Furthermore, the diameter of the access opening through which the mixing unit was inserted has to be of sufficient length to allow the insertion of the impeller blades. In addition, if the container is substantially full, the mixing unit has to be operated with considerable care so as not to splash, or otherwise spill, the contents of the container. This often requires operating the mixing unit at speeds and power settings insufficient to properly agitate, mix or blend the contents of the container.

After the containers have arrived at their destination or sometimes at an earlier time, the mixing unit must be withdrawn and the container closed after the mixing operation was concluded. This may be a complex and expensive operation if the container must be sealed to preclude either the loss of vapors or the introduction of outside air.

At present, a good deal of time and money is spent cleaning and sealing bulk containers and the associated mixing units. In particular industries such as the pharmaceutical, chemical, and paint industries require the purity of their transported products be maintained. (for example a small contaminant in a paint container can result in costs upwards of $15,000, and contamination of pharmaceuticals may have even higher damages).

Mixing units are usually used on multiple containers and require extensive cleaning each time they are moved from one container to another. At present the containers and mixers are cleaned after each use, resulting in high costs (both environmentally and in equipment/manpower). For many fluids used in the paint, chemical, and pharmaceutical industries the slightest contaminant left from ineffective cleaning may ruin the fluids in the container. Further substantial costs are also incurred through the expense of using and disposing of cleaning agents such as solvents. Finally, there is a manpower cost in the amount of time required to open, mix, close and seal each container.

The most common mount for mixing units in the prior art is a bridge mounting that supports the mixing unit above the vessel neck. This assembly, however, frequently allows contaminants into the vessel.

Another solution in the prior art is the use of fully enclosed mixing units within stainless steel bulk containers. This requires extensive and often imperfect cleaning after each use which may contaminate the container contents. This cleaning process is labor intensive because of the extreme level of purity required for the re-use of these containers. The use and disposal of powerful solvents and cleaning agents also create a large cost.

Another solution in the prior art is to support mixers by the use of expensive threaded metal lids for mounting the mixer. These lids rely on the threads of the neck and collar of the container to support the loads applied during mixing and often result in cracking of the bulk container and failure of the mount.

Another prior art method of mixer support is to machine a metal cover to support the mixer with an internal thread to match the thread of the lid. This requires the mixer manufacturer to create a large number of relatively expensive mixer support covers such that the cost becomes prohibitive.

Another method of mixer support is to drill through the cover of the container and screw the mixer bearing housing through the container. This often results in splitting the cover and reduces the integrity of the container.

Yet another method of mixer support is a clamping device positioned around the neck of the container. This may cause difficulties as the clamping shoe inside the housing may collapse the neck of the container. This mount may also rotate on the neck of the container.

What is needed is an inexpensive, one time use product that can be fully recycled. Preferably, the cost of a new bulk container with a mixing unit is less than the cost of cleaning a stainless steel unit alone. Therefore, the recyclable plastic bulk containers can be used once, remanufactured and then put into use again. This avoids the costs of labor and eliminates the cost harsh cleaning compounds can have on the environment.

### SUMMARY OF THE INVENTION

According to the invention, a mounting assembly is provided that comprises clamping means to hold a mixer to a container, said clamping means dispersing the load of the mixing drive between the lip of the container and a collar, or lip mount. This assembly provides a fully enclosed mixing mount for use inside the container. The lip mount allows for mixing in the container while preserving the integrity of the container (when compared to a threaded metal lid mount), and for a low cost (when compared to a stainless steel bulk container, or the recycling process involved in prior art mixing assemblies). It is, therefore, a primary object of the present invention to provide a mixing assembly which facilitates agitating, mixing and/or blending of fluids that are shipped and stored in containers, particular plastic bulk containers.

Another object of the present invention to provide a mixing unit which permits an impeller module to be quite easily, and if wanted, permanently, affixed to a container and that is readily accessible for operation by a power module that can be detachably secured to the impeller module.

It is yet another object of the present invention to provide a mixing assembly, as above, that allows the power module to be detachably secured to the impeller module such that there is no need for a person securing said power module to use tools, or to insert his or her hands in an area where injury could result.

It is yet a further object of the present invention to provide a mixing assembly that employs a locking means to prevent inadvertent disengagement of a fast make/break connector.

It is a still further object of the present invention to provide a mixing unit, as above, wherein the impeller unit, when affixed to a container, presents a low profile so that it does not interfere with stacking of the containers.

These and other objects of the invention, as well as the advantages thereof over existing and prior art forms, which will be apparent in view of the following detailed specification, are accomplished by means hereinafter described and claimed.

In general, a mixing unit embodying the concepts of the present invention is adapted for use in conjunction with “tote vessel” containers or other portable containers of the type employed to transport, store, mix and/or discharge fluids.

An impeller module may be relatively permanently affixed to such a container. The impeller module comprises a bearing housing and an impeller shaft rotatably mounted within the bearing housing. One or more impellers are secured to the shaft and disposed interiorly in the container for rotation around with the shaft.

A fluid mixing unit embodying the concepts of the present invention is shown by way of example in the accompanying drawings and described in detail without attempting to show all of the various forms and modifications in which the invention might be embodied; the invention being measured by the appended claims and not by the details of the specification.

### DESCRIPTION OF THE DRAWINGS

FIG. 1a is a side cross-sectional view of a first embodiment of an assembly according to the invention;

FIG. 1b is a side cross-sectional view of a second embodiment of an assembly according to the invention;

FIG. 2a is an exploded side view of the first embodiment;

FIG. 2b is an exploded side view of the second embodiment;

FIG. 3a is an exploded perspective view of the first embodiment;

FIG. 3b is an exploded side view of the second embodiment

FIGS. 4a and 4b are side and bottom views, respectively of a cover therefor; and

FIG. 5 is an exploded perspective view of a portion of the second embodiment of the assembly.

### DETAILED DESCRIPTION

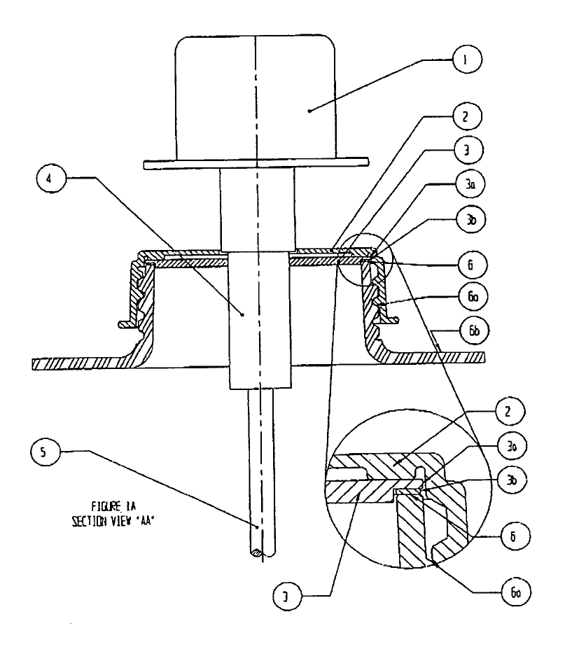

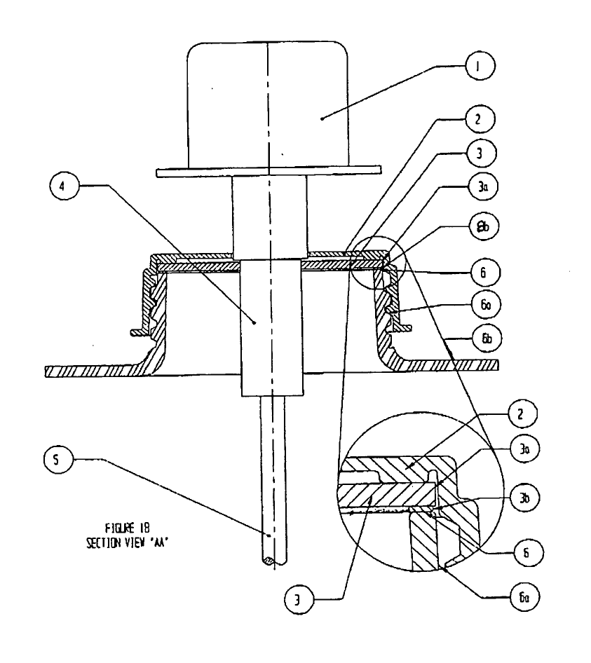

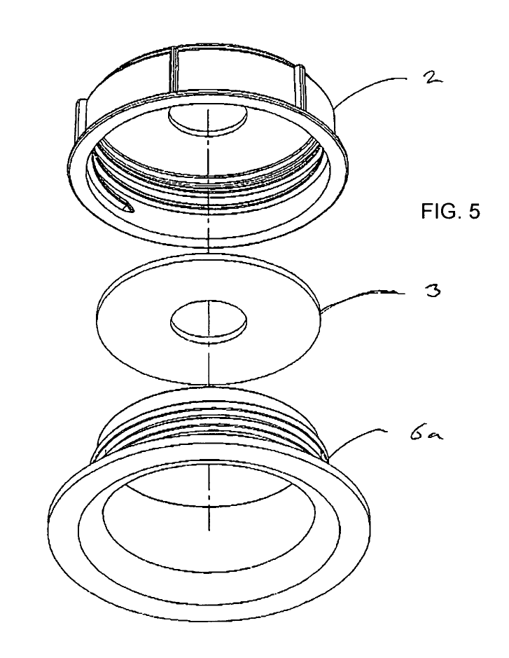

As seen in FIG. 1a, a first embodiment of the invention is an assembly, generally indicated as 10, for mounting mixing means to a container 6b. Mixing means may be of any kind found in the art, and generally comprises an engine or other propulsion device, a rotatable shaft 5, a housing 4 surrounding at least the upper portion of shaft 5, and impellers to mix the contents of container 6b. In this document, the terms “mixer” and “mixing means” will be used interchangeably. Container 6b is preferably made of plastic, and may be any one of the many bulk containers available in the art. Container is made to hold large amounts of material to be transported, usually fluids. The invention uses a lip mount 3 to stabilize and support the mixer on the lip 6 of said container 6b. Lip mount 3 is generally disc shaped as best seen in FIG. 5 and is preferably made of a hard rigid material such as metal that can distribute the weight of the mixing means. Lip mount 3 may be machined to match any size neck lip economically. Lip mount 3, when in position on lip 6, acts as a support for the mixer inserted through lip mount 3, into container 6b. Lip mount 3 preferably has a circumference equal to the outside diameter of lip 6 of the neck of the container such that lip mount 3 can rest on top of lip 6, and lip mount 3 has a threaded inside diameter sized to receive threaded mixer bearing housing 4.

In a preferred embodiment of the invention, a gasket 3b is preferably secured by glue or other conventional means to the edge 3a of the underside of lip mount 3. Gasket 3b is positioned to engage the outer side of neck lip 6 to provide further support for lip mount 3. Lip mount 3 is positioned between the lip 6 of the cylindrical neck 6a of container 6b. Neck 6a has external screw threads, and receives cover 2, allowing lip mount 3 to act as collar. Cover 2 secures lip mount 3 by engaging the threaded fasteners on the container neck 6a to hold lip mount 3 into position. Cover 2 can accommodate the numerous types of threads on the different bulk containers as the original lid for container 6b can be used with a modification accomplished by cutting an aperture through cover 2 to accommodate the mixer bearing housing 4.

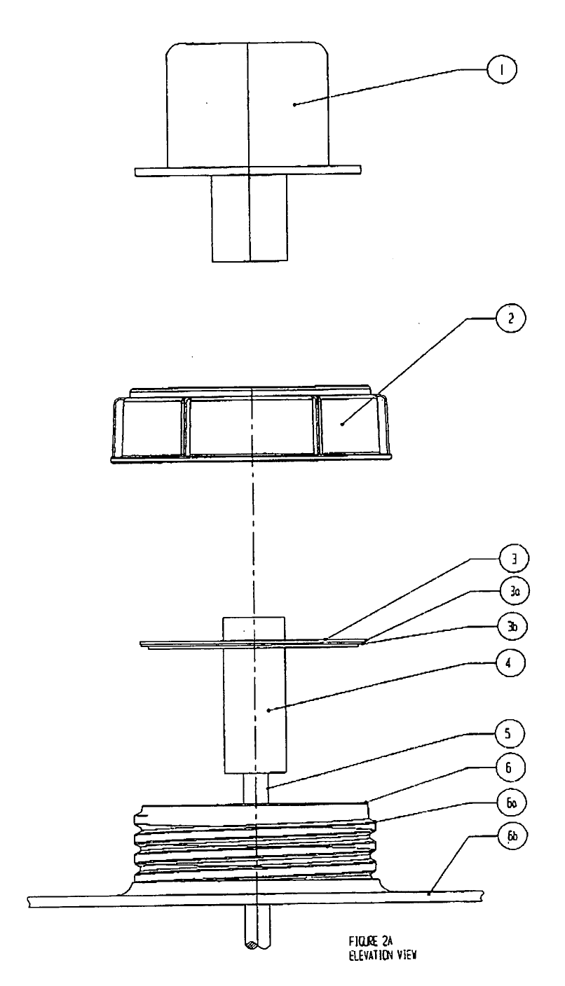

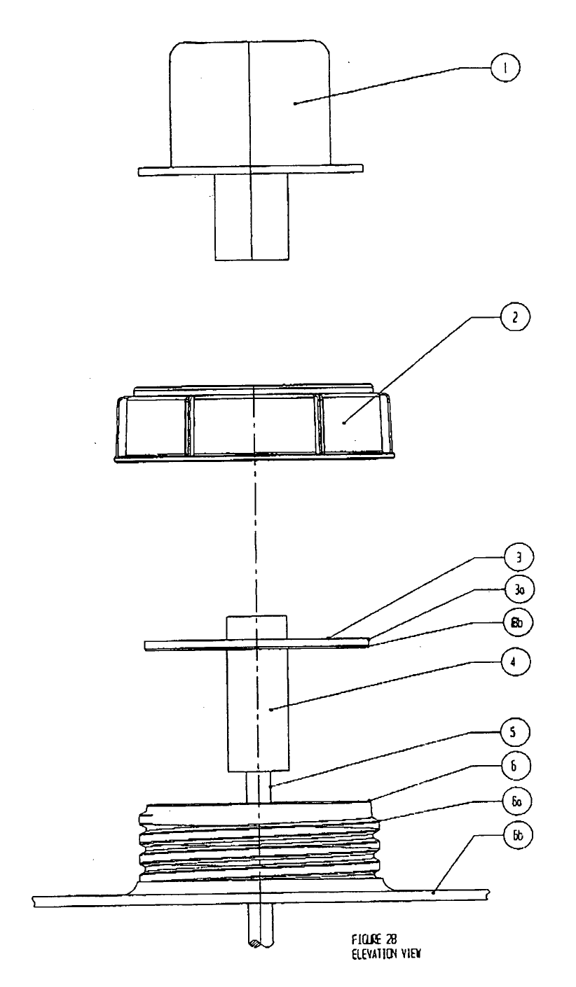

As best seen in FIG. 2a, container neck 6a consists of the extension from container 6b, and ends at lip 6. Mixer shaft 5 is inserted though neck 6a of container 6b to reach the interior of container 6b. The top of shaft 5 and bearing housing 4 are supported and sealed in container 6b by lip mount 3 which allows the mixer assembly to rest on the cover 2 of the container 6b. Housing 4 of shaft 5 and lip mount 3 are shaped to threadably engage.

In a preferred embodiment, the assembly uses a quick release male/female connection, in which cover 2 threadably engages neck 6a and may be screwed on to neck 6a to compress lip mount 3 into place. If the unit does not have a quick release male/female connection, a modified container lid may be included as part of the mixer and inserted above lip mount 3 and below mixer drive 1. This complete assembly may then be inserted into and onto the lip 6 allowing cover 2 to be engaged as above.

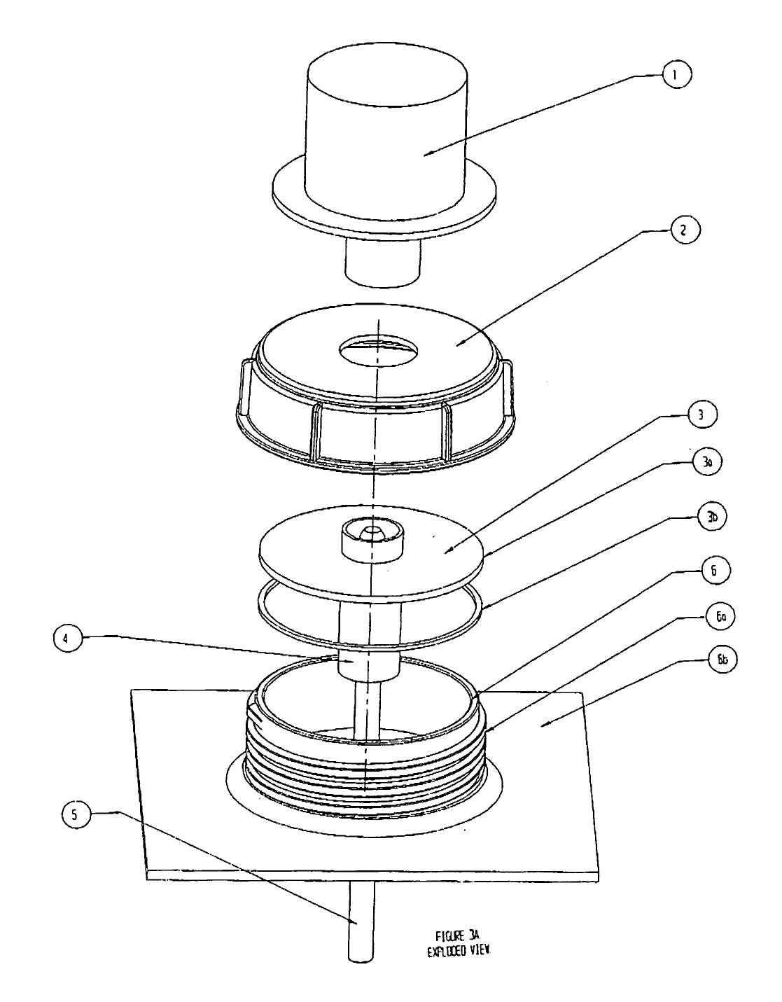

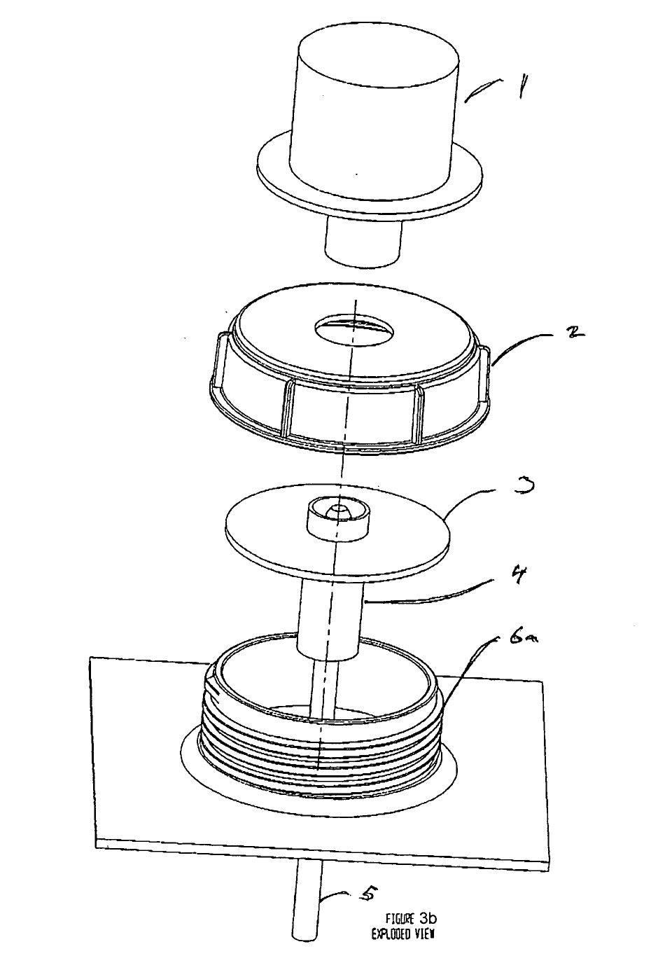

A seen in FIG. 3a, housing 4 is threadably engaged with lip mount 3 allowing shaft 5 to extend downwardly into container 6b. The bottom portion of mixer drive 1 couples with the top portion of housing 4, but lip mount 3 prevents mixer drive 1 from passing further into container 6b.

An embodiment of the invention includes an assembly for agitating, mixing and/or blending fluids affixed to container 6b using lip mount 3. Lip mount 3 is compressed between threaded container neck 6 and a threaded cover 2. Using the assembly according to the invention the weight of the mixer is supported vertically, so there is no force on neck 6a to cause collapse. The positioning of lip mount 3 between the container lip 6 and cover 2 causes the mixer 1 to be supported by the combined structure of both cover 2 and lip 6. The light weight of the lip mount 3 reduces the overall weight of the mixer by distributing the weight, as compared with prior art systems and assemblies.

Impeller shaft 5 is rotatably mounted in bearing housing 4 to rotate an impeller secured to shaft 5. This impeller is sealed within the interior of the container 6b.

The assembly also preferably includes a power module that is detachably secured to the impeller module by a locking male/female connector (not shown). The first component of the connector is mounted on lip mount 3, and is presented from the bearing housing 4, and the second component thereof is presented from the power module. This coupling allows a driving connection between the power module and the impeller shaft. When the agitator is operated to mix the liquid the drive motor 1 module drives the agitator shaft 5.

In an alternative embodiment of the invention as seen in FIGS. 1b, 2b, and 3b no gasket is used. Instead the underside 8b of lip mount 3 may be padded to help it secure to lip 6.

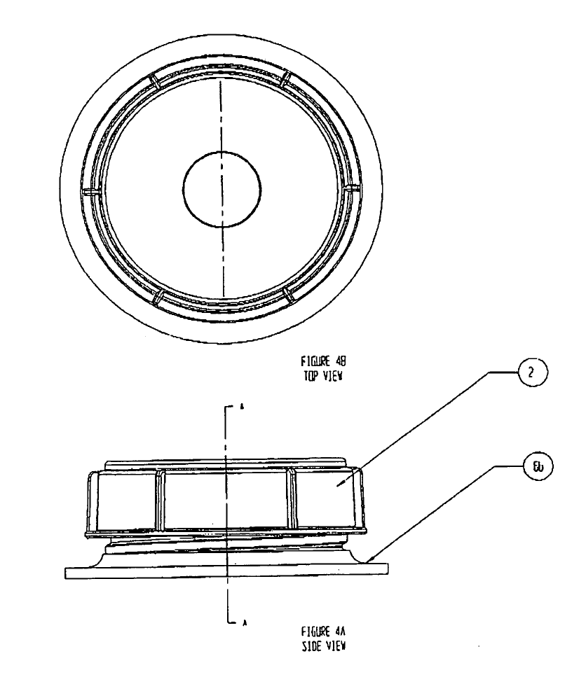

As best seen in FIGS. 4a and 4b cover 2 is a standard cover for use with containers in the filed. However, cover 2 has an aperture through which the bottom portion of mixer drive 1 and shaft 4 can pass. The assembly according to the invention positions the mixer in the center of cover 2 (as part of the cover) so that cover 2 can be rotated around the mixer, clamping the assembly into place. Thus the only piece that requires turning is the cover rather than rotation of the mixer mounted on s machined cover

A mixer system for aggressive (e.g. toxic, hazardous, corrosive, etc.) materials which need to be are mixed (or agitated, suspended, circulated, etc.) in a container 6b with an impeller connected to shaft 5 will have the impeller and its shaft 5 mounted in an assembly 10 which will extend through an opening into the container 6b after which the opening will be sealed by a cover 2.

The assembly according to the invention using removable impellers can be installed at the factory where container 6b is filled. Cover 2 can be closed, sealed and shipped with the mixer, assembled as part of the container 6b. Before emptying container 6b, the drive unit 1 is mounted to the mixer assembly without removing cover 2. The mixer can be operated as the fluids are drawn out of container 6b. Therefore container 6b can remain closed until it is emptied, and no contaminants will enter the container 6b during the time the container is filled, shipped and emptied. The assembly according to the invention preferably weighs less than twenty pounds and can be easily installed or removed by one person.

Container 6b may be made from plastic, stainless steel or other material. Stainless steel containers are typically used for shipping paint from the paint manufacturer to the users (e.g. car manufacturers). These containers are then returned to a company for cleaning with heavy solvents or caustics and acid. The cleaning materials used are very expensive and are environmentally hazardous. The cleaning process also increases transportation costs significantly. The use of plastic bulk containers with the integrated lip mount, allows the use of recyclable plastic bulk containers. This eliminates the high cost of handling the containers and the cost of the cleaning solutions.

The assembly is typically provided with a collapsible impeller, capable of passing through a 5″ diameter neck and open to a 16″ diameter impeller to provide vigorous mixing and a detachable drive 1. Preferably the drive 1 will have a minimum protrusion for allow the containers to be stored in close proximity.

Although the particular preferred embodiments of the invention have been disclosed in detail for illustrative purposes, it will be recognized that variations or modifications of the disclosed apparatus lie within the scope of the present invention.

The embodiments of the invention in which an exclusive property or privilege is claimed are defined as follows:

1. A mounting assembly for a container having a neck with a lip, comprising:
a) a rigid lip mount shaped to fit on top of said lip, said lip mount defining an aperture shaped to threadably engage a housing for a shaft;
b) a cover for the container, said cover shaped to secure said lip mount to the lip by threadably engaging with the neck, said cover defining an aperture shaped to allow passage of said housing;
c) mixing means comprising a shaft with a housing, a motor and an impeller.

2. The mounting assembly of claim 1 wherein said lip mount is disc shaped.

3. The mounting assembly of claim 2 wherein said lip mount is made of metal.

4. The mounting assembly of claim 3 wherein said cover is shaped to threadably engage said housing.

5. The mounting assembly of claim 4 further comprising a gasket shaped to support said lip mount on top of said lip.

6. The mounting assembly of claim 4 wherein the underside at the edge of said lip mount is padded.
